(19) United States
(12) Patent Application Publication
(10) Pub. No.: US 2005/0163908 A1
(43) Pub. Date: Jul. 28, 2005

(54) Beverage and method of making a beverage

(76) Inventor: Deon Anson, Philadelphia, PA (US)

Correspondence Address: National IP Rights Center, LLC, Suite 400, 550 Township Line Road, Blue Bell, PA, 19422, US

(21) Appl. No.: 10/764,331

(22) Filed: Jan. 23, 2004

(51) Int. Cl. A23F 3/00

(52) U.S. Cl. 426/597

(57) ABSTRACT

A beverage and method of making a beverage is disclosed. The beverage includes ½ cup of sugar, ½ cup of fructose fruit sugar, ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, 1 ounce of orange pekoe tea, 1 ounce of pekoe cut black tea, and 1 gallon of carbonated water. The method of making the beverage includes the steps of boiling ½ cup of water, 1 ounce of orange pekoe tea, and one ounce of pekoe cut black tea; straining the liquid off in a large container; adding ½ cup of sugar, ½ cup fructose fruit sugar, ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, and 1 gallon of carbonated water; and stirring the mixture until it is dissolved.

### FIELD OF THE INVENTION

The present invention relates to beverage recipes and in particular to a beverage and method of making a beverage.

### BACKGROUND OF THE INVENTION

The desire for an enjoyable beverage knows no limitations. From time immemorial, human beings have been experimenting with various combinations of foods to add to beverages in order to make them tastier and more enjoyable. Companies, and individuals who create soft drinks are always looking for a new combination that will help them to serve this consumer need. Particularly popular drinks are soft drinks such as cola, iced tea, and lemonade. Numerous inventions for improving and creating new foodstuffs are currently on the market.

U.S. Pat. No. 5,260,083 to Brain et al. discloses an edible fruit spread in a form similar to a jelly or jam having improved texture and flavor characteristics and a decreased dissipation rate in the mouth during consumption is prepared by incorporating a pectin, starch, cellulose, carrageenan or protein based fat mimetic into a fruit spread recipe.

U.S. Pat. No. 5,258,198 to Bastian et al. is directed towards a process for making pepper-kraut. The method includes Selecting large Hungarian/Rromanian hot peppers of seasonal colors, preparing the peppers for stuffing by washing the peppers, cutting off their tops, extracting the seeds and rinsing the cut, de-seeded pepper, stuffing the prepared peppers with sauerkraut, placing the stuffed prepared peppers in a clean quart glass canning jar, said canning jar containing one teaspoon of Kosher canning salt and cut fresh dill, adding a brine solution to the filled quart glass canning jar to completely immerse the stuffed pepper, said brine being prepared by boiling and mixing two cups of white vinegar, one cup of water and two cups of granulated sugar, and preserving the product by refrigeration or by heating the prepared jars in a hot water bath at 165. degree. F. for ten minutes and allowing the processed jar to cool for storage to obtain a preserved sweet and sour pepper kraut product.

U.S. Pat. No. 4,693,900 to Molinari discloses long life pasta shapes suitable for constituting the first course, consisting of portions of pre-cooked, de-aerated, pressed, sterilized and processed alimentary paste. The alimentary paste may be dry, fresh or egg pasta or rice and may be cooked with sauce or flavored according to the typical recipes of the Italian regions. The shapes are ready to eat as a quick meal after being heated in the oven, grilled or fried.

U.S. Pat. No. 4,393,090 to Coroneos is directed towards an improved beef product for cooking, particularly for cooking on a vertical rotisserie. The product includes a list of ingredients to be mixed with beef. The recipe lists the ingredients by percentages in the order of predominance. The disclosure also provides the manner of processing the beef product and the equipment used in the process.

U.S. Pat. No. 4,396,817 to Eck et al. is directed towards a method of browning food in a microwave oven. The method comprises alternating over the entire cooking cycle the application of power to a microwave generating device with the application of power to an infrared heater. The operational periods of each type of radiation device are automatically varied over the cooking cycle. The parameters of these periods are empirically predetermined for each broad category of food and retained in a nonvolatile memory. In one embodiment, the periods are adjusted to compensate for varying quantities of food and desired donenesses by relating them to a total cooking time per unit mass empirically predetermined for each food category and doneness. Alternatively, the periods are adjusted by entering the food mass into a microprocessor in the oven. The microprocessor calculates the cooking time by use of the food category, food mass and power input to the microwave generating device. In either embodiment, the recipe may also include varying the microwave power and providing cooling air. Compensation for variations in initial heater temperatures are provided to allow cooking of a second item of food immediately after cooking a first item.

U.S. Pat. No. 5,356,648 to Kortschot is directed towards a frozen dessert such as ice cream, and a process for manufacturing same. The chocolate or other flavoring composition is injected into the stream of semi-frozen dessert in the form of a pumpable semi-liquid which freezes into ribbons or strands upon contact with the dessert. The fat and oil fractions of the flavoring composition are formulated so that the composition can be conditioned from a solid or semi-solid paste into a high-viscosity semi-liquid composition which can be pumped with a positive-delivery pump, and so that as soon as the composition is cooled a few degrees by being in direct contact with the ice cream, the viscosity rises rapidly and the composition once again becomes a solid or semi-solid. The conditioning can be accomplished in one of at least two ways. Firstly, the flavoring composition can be conditioned from the temperature at which is is a semi-solid paste, to a few degrees above that temperature. Secondly, the flavoring composition can be fully melted at an elevated temperature, and then supercooled to below the temperature at which it would be a semi-solid paste under steady-state conditions, agitating it to prevent crystallization. The preferred formulation for the flavoring composition is 46.61% fractionated and partially hydrogenated vegetable oils, 32.95% sucrose, 20.04% cocoa powder, and 0.40% lecithin. The vegetable oil composition is 91.8% Oleic, Stearic and Palmitic fractions, namely 10.8% Palmitic, 7.3% Stearic, and 74.7% Oleic.

U.S. Pat. No. 5,106,643 to Laufer discloses a process for preparing food products having adjustable energy and nutritional values which comprises, in that sequence, (a) preparing an emulsion of a milk product such as whole milk, nonfat milk, powdered milk and the like, (b) freezing this emulsion and (c) then thoroughly and intimately admixing this frozen emulsion with a meat, fish, vegetable, grain, fruit, cheese etc. product. By suitable selection and adjustment one to the other of the milk component with the other component, products having different caloric and energy values can be obtained. These products are distinguished by fine taste, texture and stability.

U.S. Pat. No. 4,935,259 to Vella is directed towards a method for preparing sweet-and-sour sauce. The sweet-and-sour sauce combines a duck sauce with grenadine and granulated garlic wherein the grenadine is stirred gently into the mixture at room temperature, while the granulated garlic is vigorously stirred in. The mixture is then allowed to settle for at least 24 hours at refrigerated temperature.

U.S. Pat. No. 4,597,974 to Fonteneau et al. discloses edible sauce and gravy compositions incorporating as an essential ingredient a combination of rice starch and carob-bean flour, to give the compositions desirable thickness, smoothness and stability characteristics. A method for preparing such compositions is disclosed. A process for preparing already-cooked, packaged, meat or fish-in-sauce type food products utilizing the formulated sauce and gravy compositions is also disclosed.

However, none of these inventions provides a needed tasty beverage that can be enjoyed by both young and old alike. There is a need, therefore, for a beverage that provides improved taste and can be enjoyed by both young and old alike. The beverage would be convenient to make, easy to market, and would fill a need for an improved tasty beverage for drinkers who have become tired of ordinary carbonated soft drinks and fruit juices. The beverage would be able to be enjoyed at gatherings, parties, and would make a delicious thirst-quencher, but also a healthy drink and a more natural alternative to conventional soft drinks.

### OBJECTS AND SUMMARY OF THE INVENTION

It is an object of the present invention to provide a tasty beverage and method of making the beverage.

It is a further object of the present invention to provide a novel beverage made of sugar, fructose fruit sugar, fructose corn syrup, maltodextrin, citric acid, sodium, potassium citrate, fruit juice, orange pekoe tea, pekoe cut black tea, and carbonated water.

It is yet a further object of the present invention to provide a novel beverage made of ½ cup of sugar, ½ cup of fructose fruit sugar, ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, 1 ounce of orange pekoe tea, 1 ounce of pekoe cut black tea, and 1 gallon of carbonated water.

It is yet a further object of the present invention to provide a method of making a tasty beverage.

In accordance with a first aspect of the present invention, a novel beverage is provided. The novel beverage includes sugar, fructose fruit sugar, fructose corn syrup, maltodextrin, citric acid, sodium, potassium citrate, fruit juice, orange pekoe tea, pekoe cut black tea, and carbonated water.

In accordance with another aspect of the present invention, a novel lemon-lime beverage is provided. The novel beverage includes ½ cup of sugar, ½ cup of fructose fruit sugar, ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, 1 ounce of orange pekoe tea, 1 ounce of pekoe cut black tea, and 1 gallon of carbonated water.

In accordance with yet another aspect of the present invention, a novel method for making a beverage is provided. The method includes boiling ½ cup of water, 1 ounce of orange pekoe tea, and one ounce of pekoe cut black tea; straining the liquid off in a large container; adding ½ cup of sugar, ½ cup fructose fruit sugar; ½ cup fructose fruit syrup; ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, and 1 gallon of carbonated water; and stirring the mixture until it is dissolved.

### BRIEF DESCRIPTION OF THE DRAWING

The foregoing summary, as well as the following detailed description of a preferred embodiment of the present invention will be better understood when read with reference to the appended drawing, wherein:

FIG. 1 is a flow diagram of a method of making a beverage in accordance with the present invention.

### DETAILED DESCRIPTION OF THE PREFERRED EMBODIMENT

A novel beverage and method of making the beverage is described and illustrated. The novel beverage is essentially soft drink that improves upon existing softdrinks and will appeal to both the young and old alike.

The novel beverage is made from sugar, fructose fruit sugar, fructose corn syrup, maltodextrin, citric acid, sodium, potassium citrate, lemon-lime juice, orange pekoe tea and pekoe cut black tea, and carbonated water.

In a preferred embodiment of the present invention, the novel beverage is made from ½ cup of sugar, ½ cup of fructose fruit sugar, ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, 1 ounce of orange pekoe tea and pekoe cut black tea, and 1 gallon of carbonated water.

In the preferred embodiment of the present invention, lemon-lime juice is used. However, any fruit juice known to one of ordinary skill in the art may be substituted for the lemon-lime juice. For example, ½ cup of orange-pineapple juice, ½ cup of pineapple ginger juice, ½ cup of orange-strawberry juice, or 4 tablespoons of mint juice, to name only a few, may be substituted for the lemon-lime juice.

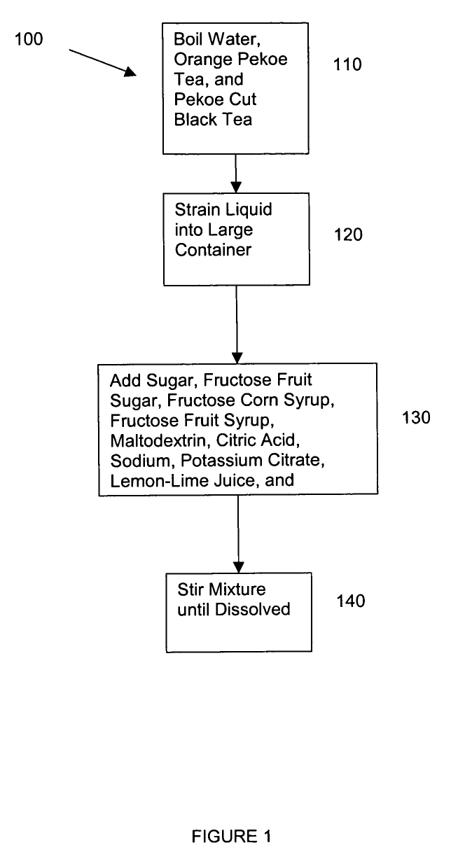

Referring now to FIG. 1, a typical method of preparing the beverage 100 is described. In step 110, the orange pekoe and pekoe cut black teas are brought to a boil in ½ cup of water. In step 120, the resultant liquid is strained off into a large container. In step 130, sugar, fructose corn syrup, maltodextrin, citric acid, sodium, potassium citrate, lemon-lime juice, and the carbonated water are added. The entire mixture is stirred as in step 140 until dissolved.

In view of the foregoing disclosure, some advantages of the present invention can be seen. For example, a novel beverage and method of making are disclosed. The beverage is a tasty new beverage that will appeal to young and old alike, is easily made, and has tremendous mass market appeal.

While the preferred embodiment of the present invention has been described and illustrated, modifications may be made by one of ordinary skill in the art without departing from the scope and spirit of the invention as defined in the appended claims.

1. A beverage, comprising:
sugar;
fructose fruit sugar;
fructose corn syrup;
maltodextrin;
citric acid;
sodium;
potassium citrate;
fruit juice;
orange pekoe tea;
pekoe cut black tea; and
carbonated water.

2. The beverage of claim 1, wherein the maltodextrin is of the type M 180.

3. The beverage of claim 1, wherein the fruit juice is selected from one of the following: lemon-line juice, orange-pineapple juice, pineapple-ginger juice, orange-strawberry juice, or mint juice.

4. A beverage, comprising:
½ cup of sugar;
½ cup of fructose fruit sugar;
½ cup of fructose corn syrup;
4 tablespoons of maltodextrin;
1½ teaspoons of citric acid;
¼ teaspoon of sodium;
¼ teaspoon of potassium citrate;
4 tablespoons of lemon-lime juice;
1 ounce of orange pekoe tea;
1 ounce of pekoe cut black tea; and
1 gallon of carbonated water.

5. The beverage of claim 3, wherein the maltodextrin is of the type M 180.

6. A method of making a beverage, comprising the steps of:
boiling ½ cup of water, 1 ounce of orange pekoe tea, and one ounce of pekoe cut black tea;
straining the liquid off in a large container;
adding ½ cup of sugar, ½ cup of fructose fruit sugar; ½ cup of fructose corn syrup, 4 tablespoons of maltodextrin, 1½ teaspoons of citric acid, ¼ teaspoon of sodium, ¼ teaspoon of potassium citrate, 4 tablespoons of lemon-lime juice, and 1 gallon of carbonated water; and
stirring the mixture until it is dissolved.
